(19) United States
(12) Patent Application Publication
(10) Pub. No.: US 2012/0114293 A1
(43) Pub. Date: May 10, 2012

(54) OPTICAL WAVEGUIDE STRUCTURE HAVING ANGLED MIRROR AND LENS

(75) Inventors: Joong-Seon Choe, Daejeon (KR); Duk Jun Kim, Daejeon (KR); Chun Ju Youn, Daejeon (KR); Jong-Hoi Kim, Daejeon (KR); Kwang-Seong Choi, Daejeon (KR); Yong-Hwan Kwon, Daejeon (KR); Eun Soo Nam, Daejeon (KR)

(73) Assignee: ELECTRONICS AND TELECOMMUNICATIONS RESEARCH INSTITUTE, Daejeon (KR)

(21) Appl. No.: 13/250,019

(22) Filed: Sep. 30, 2011

(30) Foreign Application Priority Data
Nov. 5, 2010 (KR) 10-2010-0109803

(51) Int. Cl. G02B 6/036; B05D 5/06

(52) U.S. Cl. 385/129; 427/162

(57) ABSTRACT

The present disclosure relates to a planar optical waveguide element, and more particularly, to an optical waveguide end structure for effective optical signal connection with a light source, a light receiving element, or a different type of optical waveguide element.

According to an exemplary embodiment of the present disclosure, there is disclosed an optical waveguide structure, including: a planar optical waveguide including a lower clad, a waveguide core formed on the lower clad, and a clad layer formed on the waveguide core; and an optical lens formed on a surface of the clad layer.

One end of the optical waveguide forms an inclined surface having a predetermined inclination angle.

### CROSS-REFERENCE TO RELATED APPLICATIONS

This application is based on and claims priority from Korean Patent Application No. 10-2010-0109803, filed on Nov. 5, 2010, with the Korean Intellectual Property Office, the disclosure of which is incorporated herein in its entirety by reference.

### TECHNICAL FIELD

The present disclosure relates to a planar optical waveguide element. More particularly, the present disclosure relates to an optical waveguide end structure for effective optical signal connection with a light source, a light receiving element, or a different type of optical waveguide element.

### BACKGROUND

In order for light waves to propagate in a constrained state by total internal reflection principle, without radiating to the outside, it is required a cross-sectional structure in which a specific dielectric substance is surrounded by another dielectric substance having a relatively low refractive index. A light-wave propagation path in which the cross-sectional structure is maintained can be referred to as an optical waveguide, and an optical fiber for communication is a representative example to which the optical waveguide is applied. In an optical waveguide, a dielectric substance with a relatively high refractive index is called a core, and a dielectric substance with a relatively low refractive index surrounding the core substance is called cladding or clad.

Optical waveguides may be implemented by applying an existing semiconductor process technology to upper portions of a silica (SiO₂) glass substrate, a polymer substrate, and a single crystal substrate made of silicon (Si), gallium arsenide (GaAs), indium phosphide (InP), lithium niobate (LiNbO₃), and so on. Optical elements manufactured in this way are generally called planar optical waveguide elements. Substances used for the core and cladding of an optical waveguide can be selected from substances forming the substrates appropriately for the intended use, and in order to control a refractive index and various optical characteristics, further substances may be added.

In the planar optical waveguide element, various optical circuits for performing different functions may be monolithically integrated on the same substrate. This monolithic integration makes it possible to obtain an effect that it is possible to dramatically reduce a loss of energy of a light wave in a process of optically connecting a plurality of optical waveguide elements configured as separate optical circuits.

A basic optical communication method includes a process for converting a light wave output from a light emitting element into a desired optical signal by using an optical modulation element, transmitting the optical signal to a light receiving element through an optical fiber or an optical waveguide element, and detecting the optical signal in the light receiving element. Here, the light emitting element means an element generating specific light, and the light emitting element such as a laser diode may be implemented by injecting a current into an optical waveguide made of a compound based on gallium arsenide or indium phosphide which is a direct band gap substance. The light receiving element is an element for receiving and detecting the specific light, and the light receiving element such as a photodiode may be implemented by using a phenomenon in which current is generated when the light wave is absorbed by the compound substance. The optical modulation element capable of performing high-speed digital modulation may be implemented by using electro-optic effects of lithium niobate (LiNbO₃) and indium phosphide (InP). In order to improve the efficiency of the optical communication, a loss in the energy of the light wave in an optical connection process among the light emitting element, the light receiving element, and the optical modulation elements may be reduced.

In a case where two different waveguides have a small difference in waveguide mode size, a general optical connection method is to bring ends of the two waveguides flush into contact with each other in a state in which the optical axes of the two waveguides are aligned with each other, and fix the ends of the two waveguides with an adhesive, and examples of the general optical connection method include splicing between the same type of or different types of optical fibers and bonding between a silica optical waveguide element and an optical fiber block. However, in a case where two different waveguides have a large difference in waveguide mode size, or if required in an optical packaging structure, an optical connection method using optical lenses and mirrors is generally used, and pigtails of laser diodes and photodiodes are typical examples thereof.

As described above, in the case where two different waveguides have a large difference in waveguide mode size or if required in an optical packaging structure, using optical lenses and mirrors may be an efficient optical connection method in terms of loss in energy of a light wave. However, introduction of optical lenses and mirrors makes optical axis alignment more complex and difficult.

FIG. 1 is a conceptual view of an optical waveguide structure that was proposed to solve the problem. An optical waveguide structure as shown in FIG. 1 may be manufactured by forming a waveguide core 102, having a relatively high refractive index than that of a specific glass substrate 101 acting as the clad of the optical waveguide, on a surface of glass substrate 101 by using an ion exchange method, and polishing both ends of the optical waveguide. In a case where an angle of one polished surface is inclined at 45 degrees to waveguide core 102, a light wave 103 is reflected such that the propagation direction of light wave 103 is changed by 90 degrees, and in a case where a metal layer 104 exists on the inclined polished surface, the efficiency of the reflection of light wave 103 is maximized. Also, on the other surface of glass substrate 101 where waveguide core 102 does not exist, an optical lens 105 may be formed by the ion exchange method, so as to improve the condensing efficiency of the light wave reflected by the inclined surface. Moreover, since a photolithographic process capable of precise alignment is applicable for forming waveguide core 102 and optical lens 105, the optical axis of waveguide core 102 and the optical axis of optical lens 105 can intersect each other accurately at 90 degrees.

In a case of a spherical lens, in general, the focal length is inversely proportionate to the refractive index of the lens, and is in proportion to the radius of the lens. For this reason, in the optical waveguide structure shown in FIG. 1, in order to make optical lens 105 have a very small focal length of, for example, 0.1 mm or less, it possible to increase an effective refractive index in a region where ion exchange is performed while reducing the area of a lens region where ion exchange is performed on the surface of the glass substrate. However, since a decrease of the area of the lens region and an increase of the efficient refractive index have a trade-off relationship in respects to an ion exchange principle, it is actually very difficult to reduce the focal length of optical lens 105 to 0.1 mm or less. Even when the focal length is reduced to a desired value by a reduction of the radius of the lens, since the thickness of glass substrate 101 is considerably larger than the focal length, the condensing efficiency of light wave 103 is reduced. This is basically because waveguide core 102 and optical lens 105 exist on opposite surfaces of glass substrate 101.

As described above, according to the method of manufacturing an optical wavelength structure according to the related art, since the waveguide core and the optical lens exist on opposite surfaces of the glass substrate, it is difficult to reduce the focal length of the optical lens to 0.1 mm or less, and the condensing efficiency of the light wave is reduced due to the thickness of the glass substrate.

### SUMMARY

The present disclosure has been made in an effort to provide an optical wavelength structure capable of reducing a focal length of an optical lens to 0.1 mm or less, suppressing a reduction in a light-wave condensing efficiency, and forming an optical waveguide and the optical lens on the same surface.

An exemplary embodiment of the present disclosure provides an optical waveguide structure, including: a planar optical waveguide including a lower clad, a waveguide core formed on the lower clad, and a clad layer formed on the waveguide core; and an optical lens formed on a surface of the clad layer. One end of the optical waveguide forms an inclined surface having a predetermined inclination angle.

Another exemplary embodiment of the present disclosure provides a method of manufacturing an optical waveguide structure, including: forming a lower clad;

forming a waveguide core on the lower clad; forming a clad layer on the waveguide core; polishing one end of an optical waveguide including the lower clad, the waveguide core, and the clad layer, so as to form an inclined surface having a predetermined inclination angle; and forming an optical lens on a surface of the clad layer.

In the optical waveguide structure according to the exemplary embodiments of the present disclosure, different substances are applicable as substances forming the waveguide core and the optical lens. Therefore, in a case where the optical lens is implemented by using a substance with a very high refractive index while the radius of the optical lens are maintained at a small value within an allowable range, it is possible to reduce the focal length of the optical lens to, for example, 0.1 mm or less.

Further, in the optical waveguide structure according to the exemplary embodiments of the present disclosure, it is possible to reduce a distance between the inclined end of the waveguide core and the optical lens to several tens μm or less. Therefore, even when the focal length is reduced to 0.1 mm or less due to a reduction of the radius of the lens, it is possible to suppress a decrease in light-wave condensing efficiency, unlike the optical waveguide structure according to the related art.

Furthermore, in the optical waveguide structure according to the exemplary embodiments of the present disclosure, since the optical lens may be formed on the surface of the substrate where the optical waveguide is formed, it is possible to form a plurality of optical waveguides and optical lenses on the same surface. Therefore, according to exemplary embodiments of the present disclosure, optical packaging with a light source and a light receiving element having a plurality of optical signal connection points, or a different type of optical waveguide element is easy.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a conceptual view illustrating an optical waveguide structure having an inclined mirror and an optical lens according to the related art.

FIGS. 2A to 2E are cross-sectional views of an optical waveguide for explaining a method of forming a planar optical waveguide structure according to an exemplary embodiment of the present disclosure.

FIG. 3 is a conceptual view illustrating the optical waveguide structure having an inclined mirror and an optical lens according to an exemplary embodiment of the present disclosure.

FIG. 4 is a conceptual view of a different type of optical waveguide element coupled with the optical waveguide structure shown in FIG. 3 for optical signal connection according to an exemplary embodiment of the present disclosure.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

Hereinafter, exemplary embodiments of the present disclosure will be described in detail with reference to the accompanying drawings. Configurations of the exemplary embodiments of the present disclosure and effects attained thereby will be clearly understood from the following description.

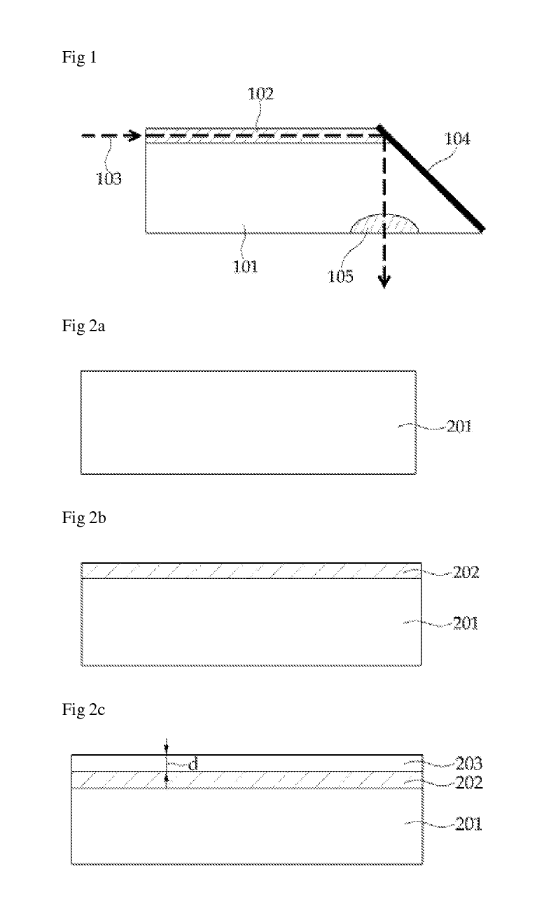

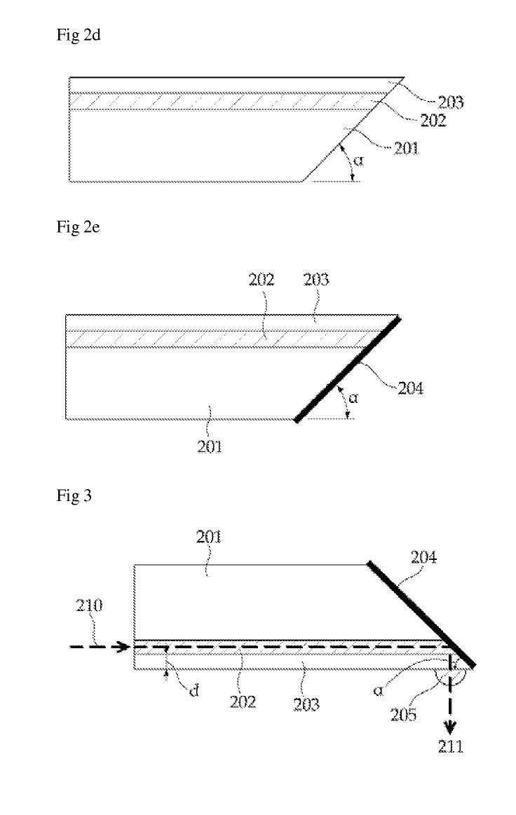

FIGS. 2A to 2E are cross-sectional views of an optical waveguide for explaining a method of forming a planar optical waveguide structure according to an exemplary embodiment of the present disclosure.

Referring to FIG. 2A, a lower clad 201 acting as a clad of an optical waveguide is provided. Lower clad 201 may act as a substrate, or have a separate layer structure existing on a specific substrate (not shown).

Referring to FIG. 2B, on a surface of lower clad 201, a waveguide core 202 having a relatively high refractive index than that of lower clad 201 is formed. For example, both of lower clad 201 and waveguide core 202 may be made of glass materials containing silica (SiO₂). In this case, in order to form waveguide core 202 with the relatively high refractive index on the surface of lower clad 201, various methods such as sputtering, chemical vapor deposition (CVD), ion exchange, and ion implantation can be used; however, the present disclosure is not limited thereto.

As another example, both of lower clad 201 and waveguide core 202 may be made of organic high molecular materials. In this case, in order to form waveguide core 202 with the relatively high refractive index on the surface of lower clad 201, various methods such as spin coating and polymerization can be used; however, the present disclosure is not limited thereto.

As another example, in a case where lower clad 201 has a separate layer structure existing on a specific substrate, the specific substrate and lower clad 201 may be made of single crystal silicon and silica glass, respectively. In this case, waveguide core 202 may be made of the same kind of single crystal silicon as that of the specific substrate, or may be made of a different kind of silica glass from the silica glass of lower clad 201, the different kind of silica glass having a refractive index higher than that of the silica glass of lower clad 201.

Referring to FIG. 2C, on waveguide core 202, a clad layer 203 acting as a clad is formed. For example, clad layer 203 may be a glass layer deposited on waveguide core 202. Clad layer 203 is considerably thinner than lower clad 201, and the thickness d of clad layer 203 may be 1 μm to 100 μm, or 10 μm to 50 μm, for example.

Referring to FIG. 2D, an end of the optical waveguide forms a predetermined inclination angle a to a bottom surface of lower clad 201. The end of the optical waveguide is polished such that the end of waveguide core 202 has the inclination angle a to a surface of lower clad 201. In order to make a propagation direction of a light wave propagating through waveguide core 202 be changed at the inclined surface of the end of the optical waveguide by 90 degrees, the inclination angle a may be set at 45 degrees. In a case where the end of the optical waveguide is polished to have the inclination angle of 45 degrees, both of the incidence angle and reflection angle of the light passing though the optical waveguide become 45 degrees according to the law of reflection of light, such that the propagation direction of the light wave is changed at the inclined surface of the end of the optical waveguide by 90 degrees.

Referring to FIG. 2E, on the inclined end surface of the optical waveguide, a reflector 204 may be formed. Reflector 204 performs a function of maximizing the light reflection efficiency at the inclined end surface of the optical waveguide. Reflector 204 may be formed of a metal layer, for example.

FIG. 3 is a conceptual view of the optical waveguide structure according to an exemplary embodiment of the present disclosure. In FIG. 3, the optical waveguide shown in FIG. 2 is shown with the upside facing down, and an optical lens 205 is formed on a surface of clad layer 203. A propagation direction of light wave 210 incident to the optical waveguide is changed at reflector 204 formed on the inclined surface of the end of the optical waveguide by 90 degrees, such that light wave 210 propagates in a direction vertical to the incidence direction, that is, toward optical lens 205.

Optical lens 205 may be a planar lens. The planar lens may be formed of a micro array lens. Optical lens 205 performs a function of condensing light wave 211 reflected by reflector 204 on the inclined end surface. The position of optical lens 205 is determined such that the optical axis of waveguide core 202, that is, an axis of the propagation direction of light wave 210 incident to the optical waveguide, and the optical axis of optical lens 205, that is, an axis of the propagation direction of light wave 210 reflected by reflector 204 intersect each other at one point. Waveguide core 202 and optical lens 205 can be formed by using a photolithographic process capable of precise alignment, such that the optical axis of waveguide core 202 and the optical axis of optical lens 205 intersect each other to accurately form 90 degrees.

In the optical waveguide structure shown in FIG. 3, waveguide core 202 and optical lens 205 may be made of different substances. Therefore, the focal length of the optical lens can be reduced by implementing the optical lens with a substance having a very high refractive index while the radius of optical lens 205 is maintained at a small value within an allowable range. Optical lens 205 may be made of a material such as silica or an organic polymer on reflector 204.

In the optical waveguide structure shown in FIG. 3, thin clad layer 203 can be formed between waveguide core 202 and optical lens 205, such that the distance d between waveguide core 202 and optical lens 205 is reduced to several tens μm or less. Therefore, in the optical waveguide structure shown in FIG. 3, since reflected light wave 210 reaches optical lens 205 through thin clad layer 203 formed on a waveguide core 202 side, not on a lower clad 201 side, a decrease in the light-wave condensing efficiency is effectively suppressed, unlike the related art in which, since the thickness of glass substrate 101 is much larger than the focal length as shown in FIG. 1, the condensing efficiency of light wave 103 decreases.

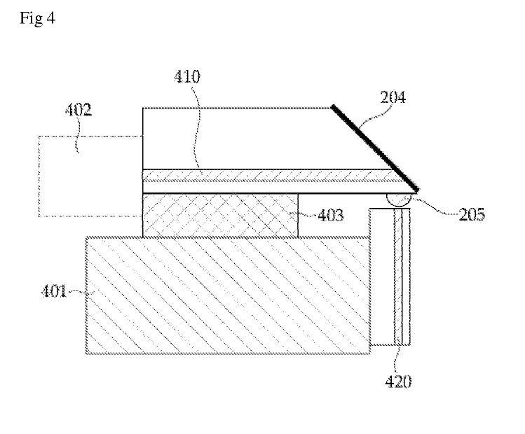

FIG. 4 shows an optical waveguide structure including a different type of optical wavelength element coupled with the optical waveguide structure shown in FIG. 3 for optical signal connection according to an exemplary embodiment of the present disclosure.

In FIG. 4, an optical waveguide 410 constituting the optical waveguide structure is positioned at 90 degrees to a different type of optical waveguide 420 fixed by a support 401 having a rectangular cross-sectional structure. Here, effective optical signal connection between optical waveguide 410 and different type of optical waveguide 420 having different mode sizes is possible by light wave reflection at the interface between optical waveguide 410 and reflector 204 and the condensing capability of optical lens 205.

In FIG. 4, different type of optical waveguide 420 positioned in a direction vertical to optical waveguide 410 is shown. However, at the position of different type of optical waveguide 420, various light emitting elements or light receiving elements may be disposed. For example, at the position of different type of optical waveguide 420, a side emission type laser diode or an optical waveguide type photodiode may be disposed. Also, on occasions, at the position of different type of optical waveguide 420, a vertical emission type laser diode or a vertical incidence type photodiode that does not need any optical waveguide may be disposed.

The optical waveguide structure shown in FIG. 4 may further include an optical fiber block 402 bonded to optical waveguide 410, and a cover substrate 403 for bonding with optical fiber block 402 and polishing may be attached on support 401.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An optical waveguide structure, comprising:
a planar optical waveguide including a lower clad, a waveguide core formed on the lower clad, and a clad layer formed on the waveguide core; and
an optical lens formed on a surface of the clad layer,
wherein one end of the optical waveguide forms an inclined surface having a predetermined inclination angle.

2. The optical waveguide structure of claim 1, wherein the lower clad acts as a substrate.

3. The optical waveguide structure of claim 1, wherein the predetermined inclination angle is 45 degrees.

4. The optical waveguide structure of claim 1, wherein an optical axis of the waveguide core and an optical axis of the optical lens intersect each other at one point.

5. The optical waveguide structure of claim 1, wherein the clad layer is formed by depositing a glass layer on the waveguide core.

6. The optical waveguide structure of claim 5, wherein a thickness of the glass layer is 1 μm to 100 μm.

7. The optical waveguide structure of claim 1, wherein the optical lens is a planar lens.

8. The optical waveguide structure of claim 1, wherein the waveguide core contains silica, silicon, or an organic polymer.

9. The optical waveguide structure of claim 1, further comprising:
a reflector formed on an inclined surface of one end of the optical waveguide.

10. The optical waveguide structure of claim 9, wherein the reflector is formed of a metal layer.

11. The optical waveguide structure of claim 1, wherein the optical lens contains silica, silicon, or an organic polymer.

12. A method of manufacturing an optical waveguide structure, comprising:
forming a lower clad;
forming a waveguide core on the lower clad;
forming a clad layer on the waveguide core;
polishing one end of an optical waveguide including the lower clad, the waveguide core, and the clad layer, so as to form an inclined surface having a predetermined inclination angle; and
forming an optical lens on a surface of the clad layer.

13. The method of claim 12, wherein the forming of the clad layer includes depositing a glass layer on the waveguide core.

14. The method of claim 12, wherein a thickness of the glass layer is 1 μm to 100 μm.

15. The method of claim 12, wherein the predetermined inclination angle is 45 degrees.

16. The method of claim 12, wherein an optical axis of the waveguide core and an optical axis of the optical lens intersect each other at one point.

17. The method of claim 12, further comprising:
forming a metal layer on an inclined surface of one end of the optical waveguide.
